(19) United States
(12) Patent Application Publication
(10) Pub. No.: US 2016/0359977 A1
(43) Pub. Date: Dec. 8, 2016

(54) System and Method for Exchanging Data Between at Least One Vehicle and at Least One Mobile Terminal

(71) Applicant: Bayerische Motoren Werke Aktiengesellschaft, Muenchen (DE)

(72) Inventors: Matthias GOEBL, Muenchen (DE); Florian KUTTIG, Muenchen (DE); Dominik SCHNIEDERS, Aachen (DE)

(21) Appl. No.: 15/241,190

(22) Filed: Aug. 19, 2016

Related U.S. Application Data
(63) Continuation of application No. PCT/EP2014/078737, filed on Dec. 19, 2014.

(30) Foreign Application Priority Data
Feb. 20, 2014 (DE) 10 2014 203 060.9

(51) Int. Cl. H04L 29/08; H04L 12/40; H04M 1/725

(52) U.S. Cl. CPC H04L 67/12; H04M 1/7253; H04M 1/72561; H04L 67/146; H04L 67/02; H04L 12/40039; H04L 67/10; H04W 84/042

(57) ABSTRACT

A system is provided for exchanging data between a vehicle and a mobile terminal. The system includes the vehicle having a vehicle computing device for executing a vehicle browser application. The system also includes a vehicle communication device which has a communication link to an application server in order to download at least one vehicle integration application to be un within the vehicle browser application. The system also includes the mobile terminal with a terminal computing device for running a user application, for example an application for controlling a vehicle function, for selecting a destination address and/or for requesting vehicle parameters. The system also includes a server which has a communication link to the terminal and the vehicle browser application and which is designed to provide indirect data communication between the user application of the mobile terminal and the vehicle integration application.

### CROSS REFERENCE TO RELATED APPLICATIONS

This application is a continuation of PCT International Application No. PCT/EP2014/078737, filed Dec. 19, 2014, which claims priority under 35 U.S.C. §119 from German Patent Application No. 10 2014 203 060.9, filed Feb. 20, 2014, the entire disclosures of which are herein expressly incorporated by reference.

### BACKGROUND AND SUMMARY OF THE INVENTION

The invention relates to a system for data interchange between at least one vehicle and at least one mobile terminal.

It is known practice for mobile terminals to be connected to the entertainment system and/or infotainment system of vehicles, for example in order to play back music files from the mobile terminal in the entertainment system of the vehicle. Modern vehicles have head units that allow vehicle parameters to be displayed on a mobile terminal. This frequently involves a radio link being set up between the head unit of the infotainment system and the mobile terminal. A corresponding system is described in WO 2011/045750 A1. A disadvantage of corresponding systems is that the software that runs on the mobile terminal needs to be developed specifically for the latter. Development of a new piece of software is time consuming. In order to render new functions available on mobile terminals, it is frequently necessary for the software within the vehicle, for example on the head unit, to be updated too. This software is also proprietary software that has been written specifically for particular vehicles and particular head units. Since this software may perform or influence safety-relevant functions, updating of this software is extremely complex. Furthermore, it is difficult to distribute updated software in the vehicles.

Furthermore, there are approaches to install web browsers in the head unit of vehicles in order to allow mobile access to the Internet within the vehicle. For this, the vehicle has, in most cases, a GSM module or a similar module for data interchange via a cellular network or a mobile radio network. There is no provision for display of internal information, for example vehicle parameters, in corresponding applications. Furthermore, there are no opportunities to influence vehicle functions via corresponding web applications.

Against the background of this prior art, it is an object of the present invention to provide a system for data interchange between at least one vehicle and at least one mobile terminal that allows efficient communication of the data and uses software that can be updated in a simple and efficient manner. Furthermore, the system is intended to be designed such that security-relevant vehicle functions are protected against unauthorized access.

This and other objects are achieved by a system for data interchange between at least one vehicle and at least one mobile terminal, wherein the system comprises:
(a) the vehicle having
   (i) at least one vehicle computation device for executing a vehicle browser application;
   (ii) at leas one vehicle communication device, which is communicatively connected to at least one application server, in order to download at least one vehicle integration application for execution within the vehicle browser application;
(b) the mobile terminal having at least one terminal computation device for executing a user application, for example an application for controlling a vehicle function, for selecting a destination address and/or for requesting vehicle parameters, and
(c) at least one switching server, which is communicatively connected to the terminal and the vehicle browser application and is designed to provide indirect data communication between the user application of the mobile terminal and the vehicle integration application.

A particular advantage of the system described is that the vehicle integration application, which preferably contains the essential logic for communication with the vehicle, is executed within a vehicle browser application, for example a web browser. In this respect, it is possible to provide an isolated area for execution of the vehicle integration application, within which area there is a precise stipulation of what access operations are permitted. Furthermore, the vehicle integration application can be updated in a simple manner since it can access predefined interfaces within the vehicle browser application. Redevelopment or further development is therefore possible in a simple manner. The vehicle browser application furthermore has the advantage that it simplifies visual display of particular data. In this regard, it is possible to access known standards, for example HTML or XHTML.

Preferably, communication between the vehicle and the mobile terminal takes place via the switching server. This indirect communication allows known standards to be used in order to set up a connection from the mobile terminal or the vehicle integration application. The switching server can be used as a type of cache or proxy that buffer-stores relevant data from the terminal and/or from the vehicle. The indirect communication furthermore ensures that the vehicle must/can communicate only with trustworthy sources via predefined interfaces. In this respect, deliberate or unwitting damage to the components of the onboard power supply of the vehicle can be avoided.

The mobile terminal can also execute a terminal browser application, wherein one or more user applications are executed within the terminal browser application. In this respect, similar advantages are also obtained for the terminal as have already been described for the vehicle. It is thus possible for the access rights to be precisely defined within the terminal browser application for the user applications too. Furthermore, simple and efficient visual display opportunities arise. The known terminal browser applications frequently work independently of the underlying mobile terminal. In this respect, it is possible for mobile telephones, tablets, tablet PCs and laptops to be used for executing the user applications, without the need for modification of the user application.

Preferably, the user application and/or the vehicle integration application is/are an HTML5 application. The user application can contain the actual application logic.

The user application may be identifiable via a uniform resource identifier (URI). Preferably, the user application can be downloaded within the terminal browser application in a simple manner by the input of a corresponding URI. In this respect, it is not necessary to install dedicated software for data interchange with a particular vehicle.

By way of example, a public application server can be used for storing and providing the at least one user application. This may be an HTTP server from which the user applications can be requested by means of input of a URL or of the URI.

The switching server may be connected to the terminal and/or the vehicle browser application by HTTP. In this respect, it is possible to use an already well established communication protocol that is also supported by many terminals. Use of the switching server eliminates the problem that current browsers cannot set up direct connections, in particular direct HTTP connections, for one another. The switching server can accept messages and data from the individual browser or web browser applications, can buffer-store said messages and data and forward them to the other browsers. It is thus used as a switching center. A further advantage of the switching server is that asynchronous communication is possible. This is particularly advantageous because vehicles and mobile terminals are moving objects that cannot always access the necessary infrastructure for communication among one another or with the switching server. By way of example, the vehicle and the mobile terminal may be in a region in which there is no network coverage. In a preferred exemplary embodiment, the vehicle browser application and/or the terminal browser application set(s) up a connection to the switching server that persists for a relatively long period. Data can then be interchanged via these open connections (“HTTP long polling”).

Preferably, the switching server is reachable via the Internet and is implemented neither on the hardware of the vehicle nor on the hardware of the mobile terminal. In a variation of this exemplary embodiment, the vehicle or the mobile terminal can implement a corresponding switching server, preferably an HTTP server, so that the switching functionality can be ensured locally.

In one exemplary embodiment, the vehicle integration application and/or the user application provide(s) different basic functions. On the part of the vehicle integration application, this may be the opportunity to display different graphical user elements, for example menus, buttons, on various display devices in the vehicle. Furthermore, vehicle functions and vehicle parameters (position, speed, etc.) may be requestable. On the part of the user application, the basic functions can include management of different user applications, and different further functionalities. By way of example, retrieval of news, the weather, emails or profile properties of the user.

The vehicle integration application may be designed to communicate with a plurality of components of the onboard power supply system, particularly vehicle actuators and/or vehicle sensors, via at least one system bus of the vehicle. In this respect, the aforementioned vehicle functions can be provided and the vehicle parameters can be requested.

The vehicle integration application may be designed to receive an inquiry regarding a vehicle parameter from the switching server, to request the vehicle parameter from a vehicle sensor and to store said vehicle parameter on the switching server.

The terminal and/or the vehicle can communicate with the switching server via a mobile radio network.

To increase safety, the application server that provides the vehicle integration application may be a dedicated server within a dedicated network. By contrast, the application for the mobile terminal may be stored within a public network in order to increase the accessibility of said application.

In a modified system or additionally, signed program code can be sent from the mobile terminal via the switching serving to the vehicle. This signed program code may be either the vehicle integration application itself or a subapplication that runs within the vehicle integration application and resorts to functions thereof.

In a further exemplary embodiment, the communication to the vehicle can be abstracted and a simulation of the functionalities of the vehicle can be performed on a mobile terminal.

The object is furthermore achieved by a method for data interchange between at least one vehicle and at least one mobile terminal, wherein the method comprises the following acts:

(a) acceptance of a first HTTP connection from the vehicle by a switching server;

(b) acceptance of a second HTTP connection from the mobile terminal by he switching server;

(c) reception of an inquiry from the mobile terminal by the switching server;

(d) association of the inquiry with the first HTTP connection and/or the vehicle by the switching server;

(e) forwarding of the inquiry via the first HTTP connection to the vehicle.

The method can be carried out within the system already described or individual subcomponents of the system described. Similar advantages to those already described in connection with the apparatus are obtained.

In particular, more reliable communication between the terminal and the vehicle is made possible, with fast and efficient interchange of the software used being ensured.

The object is furthermore achieved by means of a computer-readable medium comprising instructions for performing the method described when these instructions are executed on a computation unit.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of a vehicle with an onboard power supply system.

FIG. 2 is a schematic diagram of individual relevant components of the onboard power supply system of the vehicle from FIG. 1, comprising a head unit.

FIG. 3 illustrates schematic communication options between a head unit of the vehicle and a Smartphone.

FIG. 4 illustrates schematic scenarios for update of the software of the Smartphone and of the head unit of the vehicle.

FIG. 5 is a schematic diagram of a first exemplary embodiment for the data interchange between a Smartphone and a vehicle.

FIG. 6 is a schematic diagram of a second exemplary embodiment for the data interchange between the Smartphone and a vehicle.

In the description that follows, the same reference numerals are used for parts that are the same and have the same action.

### DETAILED DESCRIPTION OF THE DRAWINGS

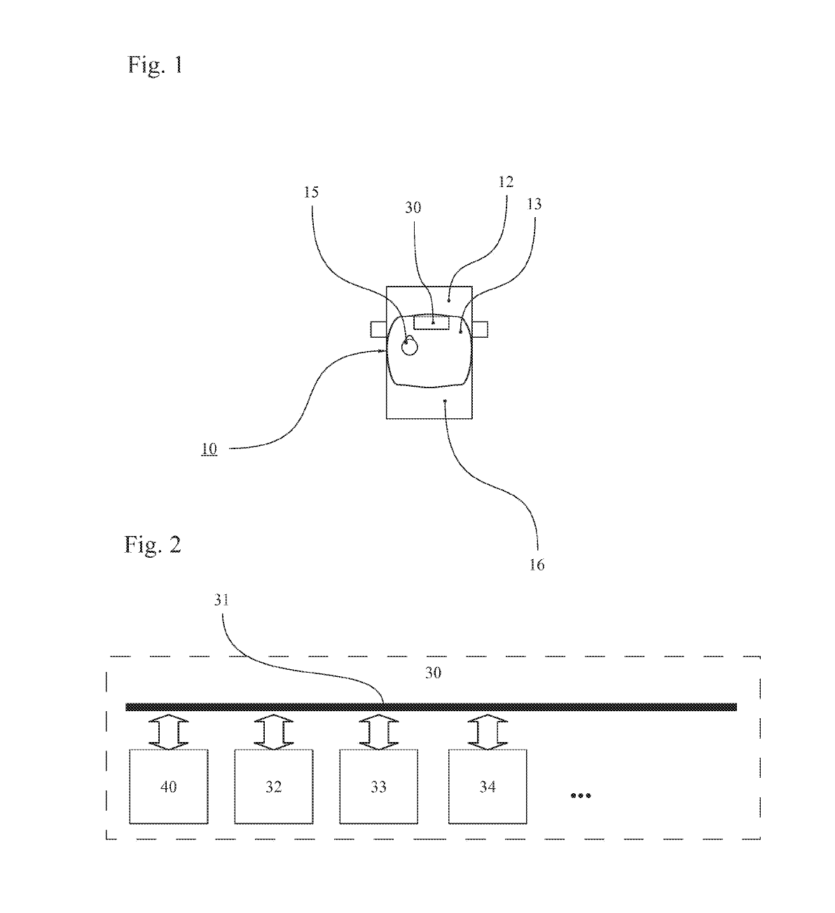

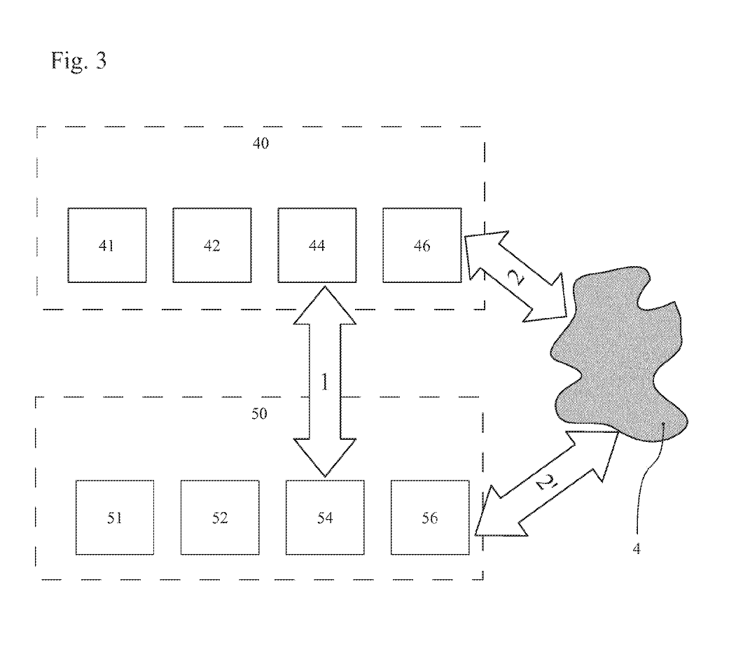

FIG. 1 shows a vehicle 10 having a vehicle front 12 and a vehicle rear 16. The vehicle has a passenger compartment 13 and has an onboard power supply system 30. In particular, the passenger compartment 13 contains a head unit 40 (FIG. 3) for the onboard power supply system 30. The head unit is in communication with a display device of the head unit 40, such as an HU display device 41, and an input unit of the head unit 40, such as an HU input unit 42.

As shown schematically in FIG. 2, the onboard power supply system 30 includes not only the head unit 40 but also a speed sensor 32, a temperature sensor 33 and a door opener 34 (as an example of an actuator). Further actuators and sensors of course may be provided. The individual components of the onboard power supply system 30 are communicatively connected to one another via a system bus 31, so that data can be exchanged.

In one embodiment, the head unit 40 can request vehicle parameters, for example a temperature by means of the temperature sensor 33, or a speed by means of the speed sensor 32. Furthermore, it is possible for the head unit 40 to trigger vehicle functions, for example using an actuator, e.g. the door opener 34. Appropriate inquiries and commands can be output by the head unit 40 via the system bus 31. Furthermore, the necessary parameters can be received by the system bus 31.

According to the invention, a system and a method for data interchange between the vehicle 10 and a mobile terminal 50 (FIG. 3) are intended to be provided.

In one exemplary embodiment, the head unit 40 comprises not only the HU display device 41 and the HU input unit 42 already described, but also a Bluetooth module 44 and an HU mobile radio module 46. The HU Bluetooth module 44 and the HU mobile radio module 46 can be used to set up a communicative connection to the Smartphone 50 (mobile terminal). Accordingly, the Smartphone 50 comprises a Bluetooth module, namely a CE Bluetooth module 54, and a mobile radio module, namely a CE mobile radio module 56. In the exemplary embodiment described, there is thus the possibility of direct device to device communication via Bluetooth, and of indirect communication via a public network, for example the Internet 4. For the indirect communication, the mobile radio modules 46 and 56 each set up a communication link via a mobile radio network.

Accordingly, there exist a first Internet connection 2 between the head unit 40 and the Internet 4 and a second Internet connection 2′ between the Smartphone 50 and the Internet 4.

These Internet connections 2, 2′ can be used in order to keep the software of the vehicle 10 and/or of the mobile terminal 50 up to date and to distribute new software with new functionality.

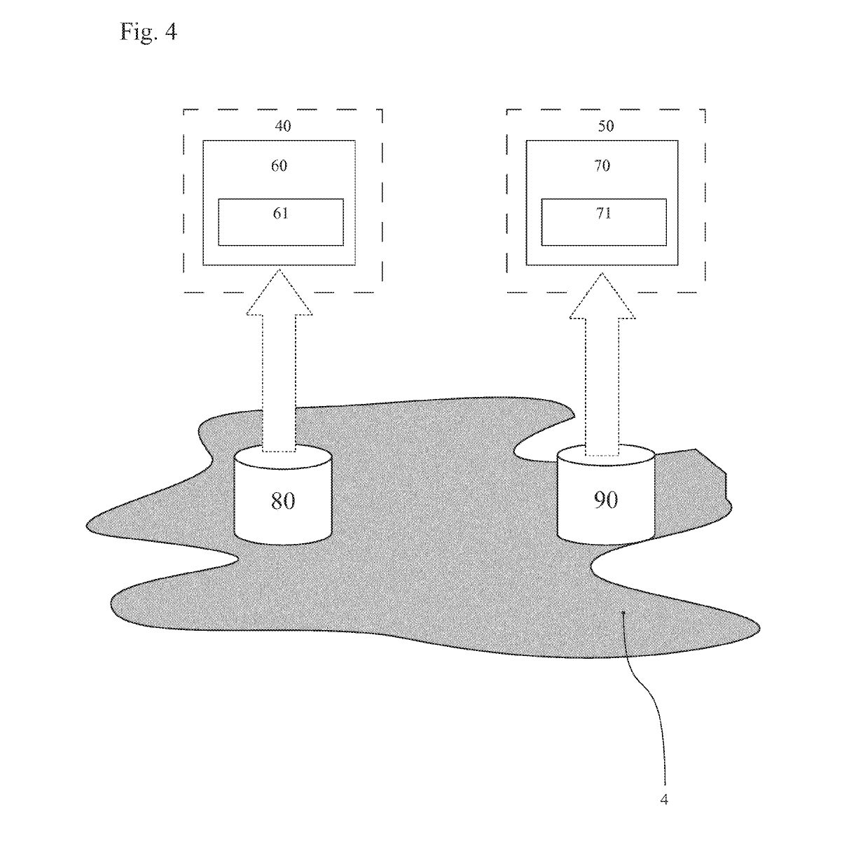

According to the invention, the head unit 40 executes a browser application, namely a vehicle browser application 60. This vehicle browser application 60 provides an environment within which a vehicle integration application 61 can be executed. Preferably, this vehicle integration application 61 is downloaded from a dedicated application server 80 (FIG. 4). This may require the vehicle 10 to authenticate itself to the dedicated application server 80. Alternatively, a dedicated network may be provided within which software is interchanged between the dedicated application server 80 and the vehicle 10, particularly the head unit 40 of the vehicle. By way of example, it is contemplated for a virtual private network (VPN) to be set up via the first Internet connection 2, and thus for secure access to the dedicated application server 80 to be provided.

In one exemplary embodiment, the Smartphone 50 also executes a web browser, namely a CE web browser 70. This CE web browser 70 is also used as an execution frame for an application, namely a user application 71, which is preferably loaded from a public application server 90. By way of example, it is contemplated for a user to simply input an appropriate URL or URI into the CE web browser 70 in order to load the current user application 71. It is contemplated for this user application 71 to be buffer stored by the Smartphone 50 or reloaded for each use.

In order to increase user convenience, there is indirect connection between the Smartphone 50 and the vehicle 10. To be more precise, a corresponding indirect connection is set up between the vehicle integration application 61 and the user application 71. This connection allows efficient data exchange between the vehicle and any desired mobile terminal, for example the Smartphone 50. This data interchange allows the user to be provided with a multiplicity of services, for example email reading on HU display device 41, email writing using the HU input unit 42, playback of music stored on the Smartphone 50, etc. Besides these applications, it is also possible for functions and parameters of the vehicle to be requested. By way of example, the Smartphone 50 can be used to unlock doors of the vehicle 10 or to switch on a vehicle heater.

It is also possible for vehicle parameters, such as the vehicle speed or the fill level of the fuel tank, to be requested by use of the Smartphone 50.

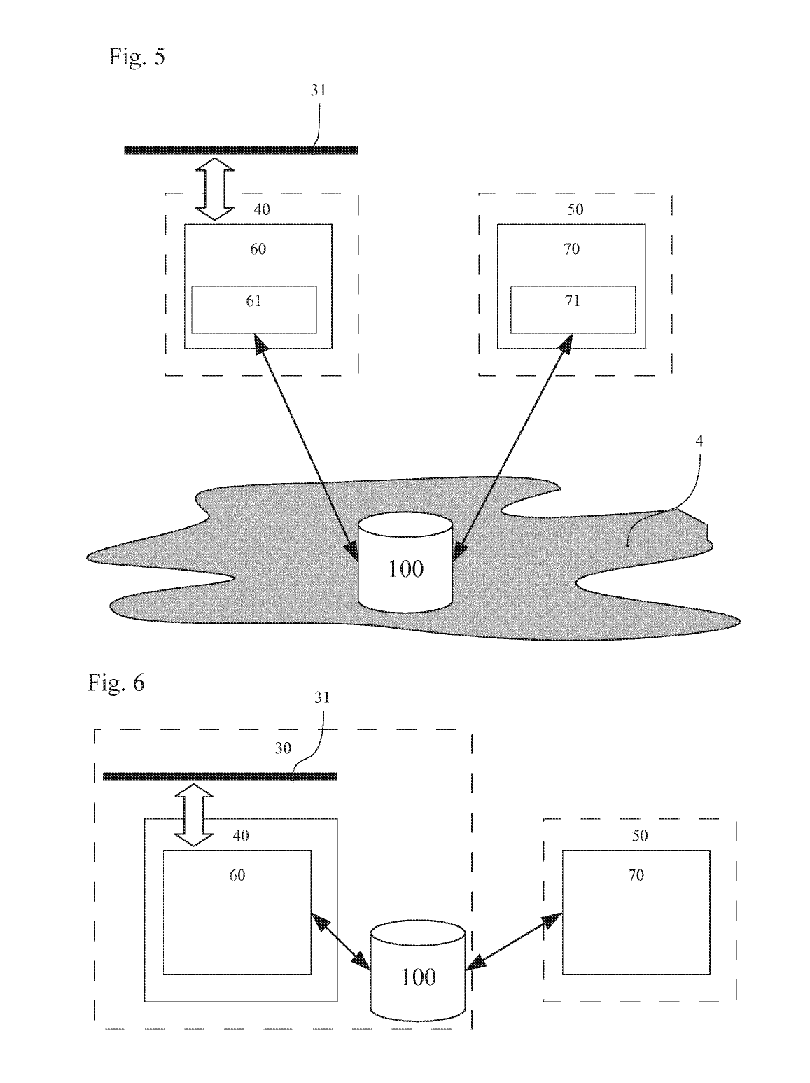

In the exemplary embodiment described in reference to FIG. 5, the indirect connection is set up via a switching server 100. On this switching server 100, the vehicle integration application 61, like the user application 71, can access the Internet 4.

In one preferred exemplary embodiment, the vehicle 10, like the Smartphone 50, sets up an HTTP connection to the switching server 100 at a relatively early time. On the basis of provided identification data, the switching server 100 knows which vehicle integration application 61 is permitted or intended to communicate with which user application 71. Similarly, the switching server 100 knows which user application 71 on which Smartphone 50 is permitted or intended to communicate with which vehicle integration application 61 on which vehicle 10. Following the setup of the indirect connection between the user application 71 and the vehicle integration application 61, data can he exchanged in any desired form. Preferably, the vehicle integration application 61 and the user application 71 are HTML5 applications that use Ajax to set up asynchronous data transmission to the switching server 100.

It is thus possible for the user application 71 to request the speed of the vehicle 10, for example. This involves an appropriate inquiry being sent to the switching server 100, which in turn forwards the inquiry to the vehicle, to be more precise the vehicle integration application 61. The vehicle integration application 61 uses an appropriate interface to communicate with the system bus 31 and is thus able to access all components of the onboard power supply system 30. By way of example, the speed sensor 32 can deliver the requested speed via the system bus 31. The vehicle integration application 61 then forwards this vehicle parameter to the switching server 100, which in turn sends this vehicle parameter to the user application 71.

In another exemplary embodiment, the vehicle integration application 61 can request appropriate vehicle parameters on the system bus 31 at prescribed intervals of time and send them to the switching server 100, which stores these vehicle parameters until the user application 71 or another application requests a corresponding vehicle parameter. Similarly, the switching server 100 can buffer store inquiries from the user application 71 until an appropriately configured vehicle integration application 61 requests and processes this inquiry.

In another exemplary embodiment shown in FIG. 6, the switching server 100 is implemented within the onboard power supply system 30. The vehicle integration application 61 can thus access a local service. In this exemplary embodiment, the Smartphone 50 can communicate with the onboard power supply system 30 via the HU Bluetooth module 44 and can set up an appropriate connection to the switching server 100. In this exemplary embodiment, the system is not reliant on the presence of a particular infrastructure, for example a mobile radio network.

It is possible for the exemplary embodiment shown in FIG. 5 and the exemplary embodiment shown in FIG. 6 to be combined. By way of example, it is possible to access the exemplary embodiment shown in FIG. 6 as soon as a radio link to a mobile radio network breaks down, so that the indirect communication link between the vehicle 10 and the mobile terminal can continue to be maintained.

Similarly, it is contemplated for the switching server 100 to be implemented on the Smartphone 50.

In the exemplary embodiments described, the communication between a vehicle 10 and a Smartphone 50 has been described. Similarly, it is possible for a corresponding communication to be set up between any other mobile terminal.

### LIST OF REFERENCE SYMBOLS

1 Bluetooth connection
2, 2′ Internet connection
4 Internet
10 Vehicle
12 Vehicle front
13 Passenger compartment
15 Driver
16 Vehicle rear
30 Onboard power supply system
31 System bus
32 Speed sensor
33 Temperature sensor
34 Door opener (actuator)
40 Head unit (HU)
41 HU display device
42 HU input device
44 HU Bluetooth module
46 HU mobile radio module
50 Smartphone (CE)
51 CE display device
52 CE input device
54 CE Bluetooth module
56 CE mobile radio module
60 Web browser
61 Vehicle integration application
70 CE web browser
71 User application
80 Dedicated application server
90 Public application server
100 Switching server

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for data interchange between at least one vehicle and at least one mobile terminal, comprising:
a vehicle having:
at least one vehicle computation device for executing a vehicle browser application;
at least one vehicle communication device, which is communicatively connected to at least one application server, in order to download at least one vehicle integration application for execution within the vehicle browser application;
a mobile terminal having:
at least one terminal computation device for executing a user application;
at least one switching server, which is communicatively connected to the mobile terminal and the vehicle browser application and is configured to provide indirect data communication between the user application of the mobile terminal and the vehicle integration application.

2. The system as claimed in claim 1, wherein the user application includes one or more of an application for controlling a vehicle function, an application for selecting a destination address, or an application for requesting vehicle parameters.

3. The system as claimed in claim 1, wherein:
the mobile terminal executes a terminal browser application, and
the user application is executed within the terminal browser application.

4. The system as claimed in claim 3, wherein,
the user application is identifiable and downloadable via a uniform resource identifier.

5. The system as claimed in claim 3, further comprising:
a public application server for storing and providing the at least one user application.

6. The system as claim in claim 4, further comprising:
a public application server for storing and providing the at least one user application via the uniform resource identifier

7. The system as claimed in claim 1, wherein
the switching server is connected to the mobile terminal and/or the vehicle browser application by HTTP.

8. The system as claimed in claim 1, wherein
the vehicle integration application is designed to communicate with a multiplicity of components of the onboard power supply system, via at least one system bus of the vehicle.

9. The system as claim in claim 8, wherein the multiplicity of components comprise one or more of vehicle actuators or vehicle sensors.

10. The system as claimed in claim 1, wherein
the vehicle integration application is designed to receive an inquiry regarding a vehicle parameter from the switching server, to request a vehicle parameter from a vehicle sensor and to store the vehicle parameter on the switching server.

11. The system as claimed in claim 1, wherein
the vehicle integration application is designed to receive an inquiry and, in response to he inquiry, to present data on at least one display device in the vehicle.

12. The system as claim in claim 11, wherein the vehicle integration application presents data loaded from the switching server on the at least one display device in the vehicle.

13. The system as claimed in claim 1, wherein
the terminal and/or vehicle communicates with the switching server via a cellular network.

14. A method for data interchange between at least one vehicle and at least one mobile terminal, the method comprising the acts of:
accepting a first HTTP connection from the vehicle by a switching server;
accepting a second HTTP connection from the mobile terminal by the switching server;
receiving an inquiry from the mobile terminal or from the vehicle for the other destination in each case by the switching server;
associating the inquiry with the respective HTTP connection from the mobile terminal or the vehicle by the switching server (100);
forwarding the inquiry from the mobile terminal via the first HTTP connection to the vehicle or forwarding the inquiry from the vehicle via the second HTTP connection to the mobile terminal.

15. The method as claimed in claim 14, further comprising the acts of:
accepting the inquiry by the vehicle;
requesting at least one parameter of the vehicle;
responding by the vehicle to the inquiry taking account of the at least one requested parameter, via the first HTTP connection.

16. The method as claimed in claim 14, further comprising the act of:
downloading a vehicle integration application, by the vehicle, wherein the vehicle integration application is designed at least to set up the first HTTP connection.

17. The method as claimed in claim 16, wherein the downloading of the vehicle integration application occurs within a dedicated network.

18. The method as claimed in claim 15, further comprising the act of:
downloading a vehicle integration application, by the vehicle, wherein the vehicle integration application is designed at least to set up the first HTTP connection.

19. The method as claimed in claim 18, wherein the downloading of the vehicle integration application occurs within a dedicated network.

20. A computer product comprising a computer readable medium having stored. thereon program code that, when executed by a processor, carries out the acts of:
accepting a first HTTP connection from the vehicle by a switching server;
accepting a second HTTP connection from the mobile terminal by the switching server;
receiving an inquiry from the mobile terminal or from the vehicle for the other destination in each case by the switching server;
associating the inquiry with the respective HTTP connection from the mobile terminal or the vehicle by the switching server;
forwarding the inquiry from the mobile terminal via the first HTTP connection to the vehicle or forwarding the inquiry from the vehicle via the second HTTP connection to the mobile terminal.
